(19) United States
(12) Patent Application Publication
(10) Pub. No.: US 2008/0164156 A1
(43) Pub. Date: Jul. 10, 2008

(54) Enzymatic method for detecting a sulfur containing amino acid using an electrochemical sensor

(76) Inventors: Xueji Zhang, Sarasota, FL (US); Dong Zhao, Tampa, FL (US); Err-Cheng Chan, Taipei (TW); Tsan-Zon Liu, Moraga, CA (US)

Correspondence Address: ALIX YALE & RISTAS LLP, 750 MAIN STREET, SUITE 1400, HARTFORD, CT, 06103, US

(21) Appl. No.: 12/006,380

(22) Filed: Jan. 2, 2008

Related U.S. Application Data
(60) Provisional application No. 60/883,618, filed on Jan. 5, 2007.

(51) Int. Cl. G01N 27/26

(52) U.S. Cl. 205/778; 205/777.5

(57) ABSTRACT

A method of detecting and measuring levels of a sulfur-containing amino acid in a sample is provided. The method includes combining an enzyme with an aqueous solution possibly comprising a sulfur-containing amino acid. When a sulfur-containing amino acid is present in the solution, it reacts with the enzyme and produces hydrogen sulfide or ammonia. An electrochemical sensor is employed to detect the presence of hydrogen sulfide or ammonia in the solution, and thereby detect the presence of sulfur-containing amino acid. The concentration of sulfur-containing amino acid present in the sample can be quantitatively measured or calculated using this method.

### CROSS-REFERENCE TO RELATED APPLICATION

This application claims the priority of U.S. Provisional Application No. 60/883,618 filed Jan. 5, 2007, the disclosure of which is incorporated herein by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of grants 1R43 GM62077-01 and 2R44 GM62077-02 awarded by the National Institute of Health (NIH).

### FIELD

The present disclosure relates generally to a method of detecting a sulfur containing amino acid in a sample using an electrochemical sensor. In one embodiment it is more particularly concerned with a new and improved method of detecting homocysteine in a biological sample using an electrochemical hydrogen sulfide sensor. In another embodiment it is more particularly concerned with a new and improved method of detecting homocysteine in a biological sample using an electrochemical ammonia sensor.

### BACKGROUND

Homocysteine is a normal metabolite of the essential amino acid methionine. Structurally, it closely resembles methionine and cysteine; all three amino acids contain a sulfur atom.

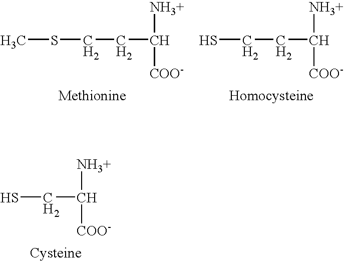

When homocysteine is transported out of cells into circulation, it reacts with other compounds containing sulfhydryl (—SH) or disulfide (—S—S—) groups. As a result of these reactions almost all of the homocysteine in circulation is converted to a homocysteine derivative comprising one or more sulfur atoms. As used herein a homocysteine derivative is a compound formed by reaction of homocysteine with another moiety, for example a protein or another amino acid. Typically, the homocysteine derivative is a disulfide (oxidized) compound including the symmetrical dimer homocysteine and mixed disulfides with cysteine and cysteine-containing plasma proteins. Other possible homocysteine derivatives include, for example, a disulfide-linked dimer, a disulfide-linked heterodimer with free cysteine, a disulfide-linked conjugate with cysteine residues of blood plasma proteins, and bonded (often as an N-Acyl derivative) to the R groups of other protein amino acids (for example, to the epsilon amino group of protein lysine). Some of these derivatives are shown below. In fact, a majority of circulating homocysteine is present as an homocysteine derivative comprising a mixed disulfide by plasma proteins. Less than 1 percent of total plasma homocysteine is found in the free (reduced) form.

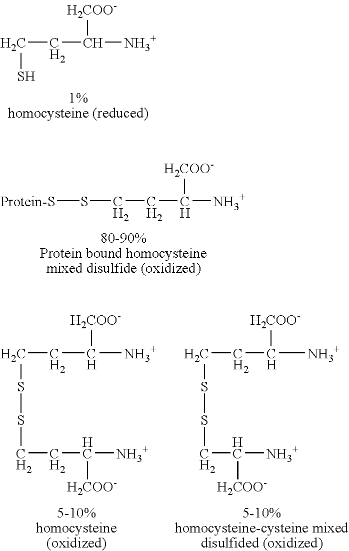

Homocysteine has been established as a major independent risk factor for cardiovascular disease. As a result sensitive and reliable assays for plasma total homocysteine (tHcy) have been developed. These assays typically treat blood plasma samples with strong reducing agents to break disulfide bonds, thus liberating free homocysteine and other small thiols such as cysteine and glutathione. The thiols are usually derivatized with a reporter group, separated and detected. Thiol-specific fluorescent reporter groups are commonly used, and separations are usually achieved by high- performance liquid chromatography (HPLC), after which the compounds are detected fluorometrically (HPLC-FD). Other methods use HPLC with electrochemical detection (HPLC-ED), or gas chromatography with mass spectrometry (GC/MS). Immunoassays for plasma tHcy are also recently available. These assays require complicated process steps, including sample reduction and derivitization, strict timing regimens and expensive equipment. Further, these assays are subject to interference by other sample constituents such as cysteine and methionine.

### SUMMARY

Briefly, an aqueous sample that may comprise homocysteine is combined with an enzyme. The enzyme reacts with the homocysteine, if present in the sample, to release a detectable amount of hydrogen sulfide or ammonia. An electrochemical sensor is used to detect the released hydrogen sulfide or ammonia and thereby indirectly detect any homocysteine in the sample. The sample may be a blood sample or derived from a blood sample.

In general, unless otherwise explicitly stated the disclosed materials may be alternately formulated to comprise, consist of, or consist essentially of, any appropriate components herein disclosed. The disclosed materials may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

When the word “about” is used herein it is meant that the amount or condition it modifies can vary some beyond that so long as the advantages of the disclosure are realized. The skilled artisan understands that there is seldom time to fully explore the extent of any area and expects that the disclosed results might extend, at least somewhat, beyond one or more of the disclosed limits. Later, having the benefit of this disclosure and understanding the concept and embodiments disclosed herein, a person of ordinary skill can, without inventive effort, explore beyond the disclosed limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

Referring now to the drawings wherein like elements are numbered alike in the several Figures:

FIG. 1 is a graph of electrochemical sensor response to 10 μM homocysteine reacted with 2.5 μg methionine α, γ-lyase in 200 μl solution at pH 6.5. The current maximized at about 194 seconds to 4678 pA.

FIG. 2 is a graph of electrochemical sensor response to 10 μM homocysteine at different pHs after reacting with methionine α, γ-lyase (square) and homocysteine α, γ-lyase (triangle). The amount of homocysteine α, γ-lyase was doubled (5.0 μg/200 μl) compared to methionine α, γ-lyase (2.5 μg/200 μl). The scale on the right side of the graph is for homocysteine α, γ-lyase response.

FIG. 3 is a graph of electrochemical sensor response to 10 μM homocysteine reacted with 2.5 μM/200 μL methionine α, γ-lyase at pH 6.5 (A), at pH 7.0 (B), and to 2.5 μM/200 μL homocysteine α, γ-lyase at pH 7.0 (C), at pH 6.5 (D).

FIG. 4 is a graph of electrochemical sensor response to 0.25-200.0 μM homocysteine to 2.5 μg methionine α, γ-lyase (square) at pH 6.5 and 1.0-200.0 μM homocysteine to 2.5 μg homocysteine α, γ-lyase (triangle) at pH 7.0. Inset: the details of low concentration ranges, i.e., 0.25-10.0 μM for methionine α, γ-lyase (square) and 1.0-10.0 μM for homocysteine α, γ-lyase (triangle).

FIG. 5 is a graph of electrochemical sensor response to the same concentrations of DL-homocysteine (1) and L-homocysteine (2).

FIG. 6 is a graph illustrating electrochemical sensor response to 10 μM concentrations of hcy. (black), cys. (magenta) and methionine (yellow).

FIG. 7 is a graph illustrating electrochemical sensor response to a 10 μM concentration of homocysteine (black) compared to 100 μM concentrations of cysteine (magenta) and methionine (yellow).

FIG. 8 is a graph illustrating electrochemical sensor response current (pA) against the weight (μg) of enzyme in 200 μl solution.

A better understanding will be obtained from the following detailed description of the presently preferred, albeit illustrative, embodiments of the invention.

### DETAILED DESCRIPTION

Enzymatic reaction of homocysteine and some enzymes will produce a stoichiometric amount of hydrogen sulfide and ammonia. This reaction is depicted below:

Homocysteine+Enzyme [symbol] α-Ketobutyrate+NH₃+H₂S

Thus, homocysteine concentrations in biological samples can be determined by reacting a sample with an enzyme which is capable of catalyzing homocysteine to produce hydrogen sulfide or ammonia followed by sensing of the hydrogen sulfide or ammonia. Such enzymes may catalyze other reactions and have different names in the literature; however, they are generally useful in the disclosed method if they possess the property of catalyzing production of a stoichiometric amount of hydrogen sulfide or ammonia from homocysteine in a sample.

It is presently preferred to detect hydrogen sulfide. An aqueous sample is collected. The sample may be, for example, a blood sample or derived from a blood sample. The sample is combined with an enzyme. The enzyme reacts with homocysteine, or an homocysteine derivative comprising a sulfur atom, in the aqueous sample to release a stoichiometric amount of hydrogen sulfide. One enzyme useful in this reaction is methionine α, γ-lyase (M-lyase) available from Formosa Biomedical Technology Corporation in Taiwan. Another enzyme useful in this reaction is homocysteine α, γ-lyase (H-lyase) available from AntiCancer, Inc. of San Diego, Calif. Presently, the methionine α, γ-lyase available from Formosa Biomedical Technology Corporation is preferred for its activity.

As previously discussed a significant fraction of homocysteine that is present in biological samples may be bonded to other biological molecules, and such homocysteine derivative forms of homocysteine are believed to contribute to pathological processes. Thus, in determining homocysteine concentrations, it is sometimes desirable to include these other homocysteine derivative forms. The total of such additional homocysteine derivative concentrations may be accurately determined by appropriate use of a disulfide bond reducing agent. Not all disulfide reducing agents are particularly suitable for this function since it has been reported that they also present the capacity to reduce disulfide bonds in enzymes that participate in thiol exchange reactions, or react directly with enzyme thiol groups, thereby altering the activity of the enzymes. One such agent is β-mercaptoethanol. A reportedly advantageous disulfide reducing agent that is highly preferred in the practice of the invention is tris-(2-carboxyethyl)phosphine (“TCEP”), available from Molecular Probes Inc., Eugene, Oreg. TCEP may be prepared fresh as a 100 mM stock solution (for use at 10 μl/1 ml tube sample) and which may be preferably dispensed into the sample vial just prior to addition of the homocysteine-containing biological sample itself.

Ammonia may be slightly less favored than hydrogen sulfide for detection since many biological samples already contain residual ammonia in the 50 to 60 μM concentration range before combination with an enzyme. Thus, this initial ammonia level in the sample must be quantified and “tared off” before combining the sample with the enzyme.

One advantageous electrochemical hydrogen sulfide sensor is the ISO-H2S-2 available from World Precision Instruments of Sarasota, Fla. Further disclosure of electrochemical hydrogen sulfide sensors can be found in International Patent Application No. PCT/US2005/036526, which was published as Publication No. WO 2006/047086 A1, the contents of each of which are incorporated by reference herein. The electrochemical hydrogen sulfide sensor is electrically connected to a device that will maintain a fixed potential of 0 mV to 1,000 mV between the working and reference electrodes of that sensor. An Apollo 4000 Free Radical Analyzer available from World Precision Instruments of Sarasota, Fla. has been found suitable for use with the electrochemical hydrogen sulfide sensor. One electrochemical ammonia sensor is available from Jumo Process Control, Inc. of Canastota, N.Y.

The following examples are included for purposes of illustration so that the disclosure may be more readily understood and are in no way intended to limit the scope of the disclosure unless otherwise specifically indicated. For simplicity the following examples will discuss one embodiment in which homocysteine is enzymatically reacted to produce hydrogen sulfide and an electrochemical H₂S sensor is used to detect the hydrogen sulfide chemical product. Naturally, the method is capable of much wider usage and the claims are not limited to the disclosed example.

Methionine α, γ-lyase was obtained from Formosa Biomedical Technology Corporation of Taiwan. The enzyme was held in a plate-like rack holding 96 small wells in an 8×12 array. Each well equally contains 2.5 μg dry enzyme. The volume of each well is slightly greater than 200 μL and enzyme was stored at −20° C. for longer terms and −4° C. for shorter terms within the well until needed. Each well was separated from others for individual experiments. The enzyme was directly dissolved into buffer solution prior to each experiment without further treatment.

Homocysteine α, γ-lyase was purchased from AntiCancer Inc. (San Diego, Calif., USA) in a formulated form and used as received. In a 2 mL amber bottle containing 0.5 mg of homocysteine α, γ-lyase, the 0.5 μg/μL enzyme solution was prepared by injecting 1.0 ml distilled water into the bottle followed by vigorous shaking. The prepared enzyme solution was then divided equally into 10 brown microcentrifuge tubes and stored in freezer till needed. The amount of enzyme used for each experiment varies from 5 μL (2.5 μg) to 10 μL (5.0 μg) depending on the scaling requirement.

Sodium phosphate saline (SPS) buffer solution was purchased as part of the homocysteine test kit from AntiCancer Inc. The pH of the concentrated solution (10×) as received is 8.0 while the diluted solution (1×) is around 7.8.

Dithiothreitol (DTT) was also purchased from AntiCancer Inc. as part of the homocysteine test kit and used without further purification.

DL-homocysteine, L-cysteine, L-methionine, dopamine, L-ascorbic acid, Trizma® hydrochloride, ammonia, potassium hydroxide, potassium nitrite, and hydrogen peroxide were purchased from Sigma (St. Louis, Mo.) or Aldrich (Milwaukee, Wis.) and were used without further purification. DL-homocysteine, L-cysteine and L-methionine solutions were made in 10 times (10×) higher than experimental concentration and stabilized by using ascorbic acid at the molar ratio of at least 1 to 1. These solutions were stored in a freezer until needed. Other solutions were prepared and were either frozen or refrigerated during the storage. L-homocysteine solution was prepared in 5 times (5×) higher than final concentration in the same way as disclosed above because each molecule would break up into two mono-molecules after reduction. Tests showed that under the protection of ascorbic acid, these amino acids could stay stable in refrigerator storage (+4+ C.) for about 12 days and in freezer storage (−20° C.) for about a month. Other solutions were prepared and were either frozen or refrigerated for storage.

Tris buffer solutions at different pH values were prepared by making 0.1 M Trizma® hydrochloride solutions followed by adjustments using either 0.1 M potassium hydroxide or 0.1 M hydrochloride solution while monitoring with a Jenco pH meter.

Hydrogen sulfide measurements were carried out using an Apollo 4000 Free Radical Analyzer and an ISO-H2S-2 hydrogen sulfide sensor, both available from World Precision Instruments of Sarasota, Fla. Deionized water was generated by running commercially available distilled water through a Millipore Simpak 1 filter. The resistivity of the deionized water was 18.2 Mohm.cm. PH measurements were made using a model-671P meter from Jenco Electronics, LTD.

Experiments using methionine α, γ-lyase were generally carried out by pipetting 180 μL of an appropriate buffer solution into the dry enzyme well with a mini-stir bar. The tip of the ISO-H2S-2 hydrogen sulfide sensor was immersed into the enzyme-buffer solution while stirring. An injection of 20 μL of an appropriate test sample can be made after the amperometric current stabilized.

Measurements using homocysteine α, γ-lyase were made in slightly different fashion from the above methionine α, γ-lyase method as the enzyme solution was premade. 180 μL of appropriate buffer solutions containing either 2.5 μg (1×) or 5.0 μg (2×) of homocysteine α, γ-lyase were prepared by mixing 175 μL or 170 μL buffer solution with 5 μL or 10 μL enzyme solution respectively, and the rest of the experimental procedures were the same as for the methionine α, γ-lyase method.

The examples used multiple batches of enzymes and amino acid solutions over a span of several months. It was found that denaturation of amino acid solutions could occur over the time and the enzyme solutions could gradually lose their activity even when stored at −40° C. Additionally, multiple sensors were used. The testing was conducted so that comparison tests, such as the pH effect tests for methionine α, γ-lyase and homocysteine α, γ-lyase (for intra-type comparison of pH effect), were done using the same sensor and the same batch of solutions of amino acid and enzyme at the nearest possible time. In this way, any discrepancies stemming from different external conditions could be minimized. The differences of enzymatic activity for the two enzymes are so great that it would be awkward to plot both of their results into the same figure for comparison purposes. The scale-ups of homocysteine α, γ-lyase dosages were preferred for certain experiments. On several occasions, mathematic scale-ups of homocysteine α, γ-lyase results were also needed in order to allow different diagrams to appear on similar scales in the same figure. The comparisons of enzymatic activity, sensitivity and response time were done separately under the same conditions and the experiments were performed on the same day using the same sensor. For other non-absolute comparison experiments, the details of the experimental and calculated scales will be indicated.

### EXAMPLE 1

### Electrochemical Measurement of Homocysteine Concentration

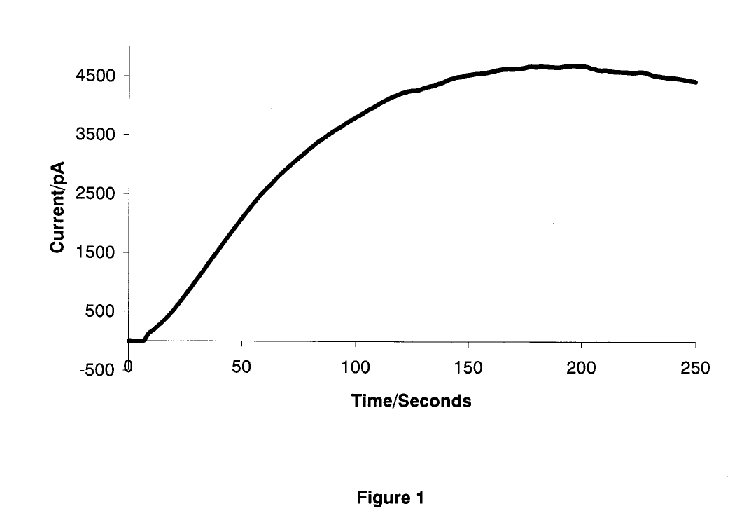

FIG. 1 reveals a typical electrochemical sensor measurement of 10 μM homocysteine at pH 6.5 pH methionine α, γ-lyase. The amperometric current peaked at 4678 pA at 194 seconds.

### EXAMPLE 2

### Effect of pH on Homocysteine Concentration Results

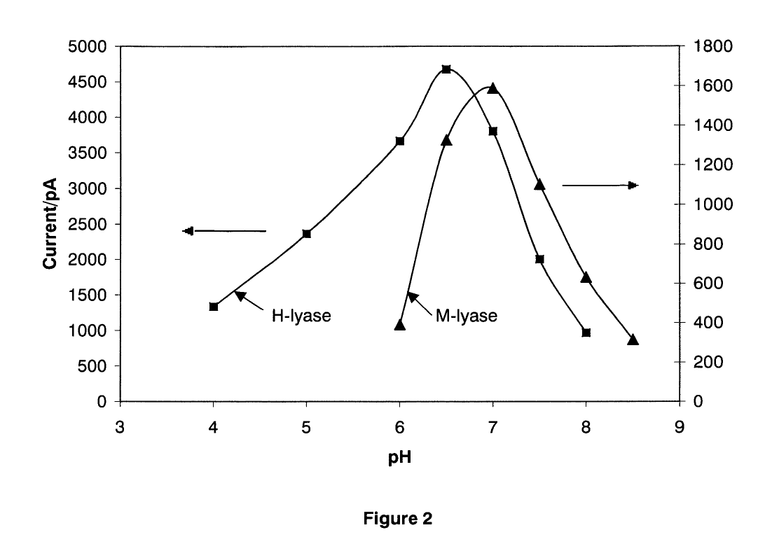

The pH dependency experiments were carried out in the most active pH ranges for each enzyme. FIG. 2 depicts results of the tests on 10 μM homocysteine separately reacted with 2.5 μg/200 μL methionine α, γ-lyase and 5.0 μg/200 μL homocysteine α, γ-lyase. Even though the enzyme amount of homocysteine α, γ-lyase used was double that of methionine α, γ-lyase, its current response was still low and had to be scaled up by a magnitude of 2.8 times numerically in order to bring its curve to the scale of the methionine α, γ-lyase responses. Examining the two response curves, these two enzymes seemed to maximize at different pH values, i.e., pH 6.5 for methionine α, γ-lyase and pH 7.0 for homocysteine α, γ-lyase. Consequently, subsequent comparisons were performed using these two pH values.

The original experimental results are tabulated in Table 1 without any scaling modification. Bearing in mind that the amounts of enzyme used were 2.5 μg/200 μL for methionine α, γ-lyase and 5.0 μg/200 μL for homocysteine α, γ-lyase respectively, responses from the lesser amount of enzyme (methionine α, γ-lyase) still exhibited almost 3-fold higher current response than the higher concentration enzyme (homocysteine α, γ-lyase). This high sensitivity suggested that methionine α, γ-lyase should be a better candidate for homocysteine sensing. Moreover, the rate of enzymatic reaction for methionine α, γ-lyase peaked at pH 7.5 at 134 seconds, while the reaction rate of homocysteine α, γ-lyase maximized at pH 8.0 at 115 seconds. The overall trend of the experiments showed that methionine α, γ-lyase's enzymatic reaction performed faster than homocysteine α, γ-lyase's. Both of the enzymes displayed their highest enzymatic rates at one pH unit away from their current peak values. It is notable that the most active (fastest response) pH value for methionine α, γ-lyase is very close to the human physiological pH value of 7.3. As the higher reaction rate would introduce less interference this pH value (or a value close to it) could be used as the operating pH value for the disclosed method using this enzyme. This feature would be advantageous for use in a homocysteine biosensor, especially an implantable sensor, as it allows the sensor to work at a normal human pH with no need to manipulate sample pH values.

Examining the high pH (basic) side of the graphs, both enzymes illustrated similar steep dropping features with pH. As the highest enzymatic rates are fall into this region a small change in pH may lead to a big loss in sensor sensitivity.

TABLE 1
Table 1. Summary of the pH dependent experiments of 10 μM homocysteine for
2.5 μg/200 μL methionine α,γ-lyase (M-lyase) and 5.0 μg/200 μL homocysteine
α,γ-lyase (H-lyase). Original data were used without any scaling modification.

| | pH | | | | | | | | |
|---|---|---|---|---|---|---|---|---|---|
| | 3 | 4 | 5 | 6 | 6.5 | 7 | 7.5 | 8 | 9 |
| Methionine α,γ-lyase | 1209 | 448 | 388 | 289 | 194 | 136 | 134 | 168 | — |
| response time at peak | | | | | | | | | |
| (secs) | | | | | | | | | |
| Homocysteine α,γ-lyase | — | — | — | 493 | 236 | 180 | 147 | 115 | 122 |
| response time at peak | | | | | | | | | |
| (secs) | | | | | | | | | |
| Methionine α,γ-lyase | 267 | 1338 | 2367 | 3668 | 4878 | 3804 | 2010 | 970 | 231 |
| response current (pA) | | | | | | | | | |
| Homocysteine α,γ-lyase | — | — | — | 391 | 1326 | 1589 | 1104 | 633 | 316 |
| response current (pA) | | | | | | | | | |

### EXAMPLE 3

### Comparison of M-Lyase and H-Lyase

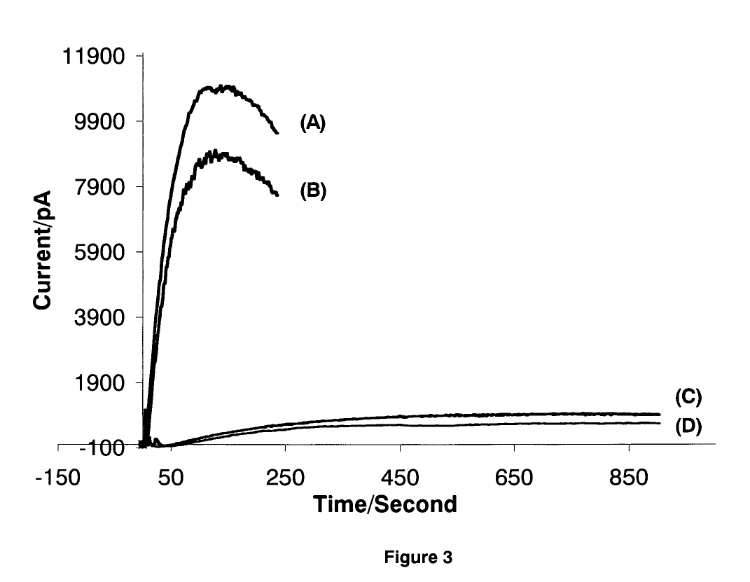

M-lyase and H-lyase illustrated their highest sensitivities at different pH values, i.e., pH 6.5 for M-lyase and pH 7.0 for H-lyase. The tests in this example were done under the same parameters (homocysteine concentration of 10 μM; enzyme amount of 2.5 μg/200 μL; the same batches of reagents; the same sensor and instrumentation setups). FIG. 3 depicts the chronic-amperometric results for both pH environments without any scaling modification. The reactivity results are summarized in Table 2 and shown in FIG. 3. A 6-fold greater reactivity for methionine α, γ-lyase than homocysteine α, γ-lyase is clearly exhibited.

Methionine α, γ-lyase illustrates a much higher sensitivity and faster reactivity than homocysteine α, γ-lyase. M-lyase expressed more than 16 times greater sensitivity at pH 6.5 and 9 times greater sensitivity at pH 7.0 than H-lyase. The ratio of their maximal peak values (at pH 6.5 for M-lyase and pH 7.0 for H-lyase) was around 11. The times for the enzymatic reactions to reach the peaks were significantly shorter for M-lyase than for H-lyase. The fast response of M-lyase is advantageous for the disclosed method using the Apollo 4000 Free Radical Analyzer system and ISO-H2S-2 hydrogen sulfide sensor, although this faster response might create handling problems for the disclosed method.

TABLE 2
Table 2. The response times for 10 μM homocysteine to react with
2.5 μg/200 μL of methionine α,γ-lyase (M-lyase) and
homocysteine α,γ-lyase (H-lyase) at pH 6.5 and pH 7.0.

pH

| | | 6.5 | 7.0 |
|---|---|---|---|
| M-lyase | (seconds) | 133 | 124 |
| H-lyase | (seconds) | 882 | 781 |

### EXAMPLE 4

### Sensitivity and Linearity

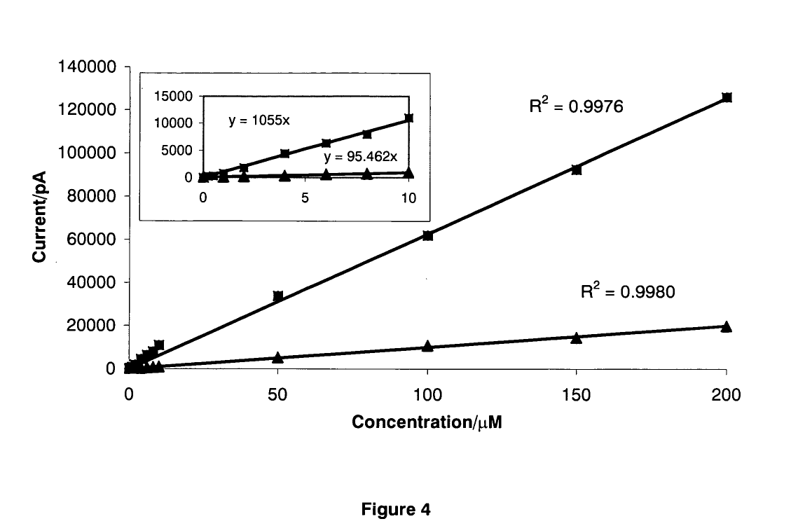

Sensitivity was tested for M-lyase and H-lyase at their most sensitive pH environments, i.e., pH 6.5 for M-lyase and pH 7.0 for M-lyase and H-lyase. The homocysteine concentration ranges for these experiments were 0.25 μM to 200 μM for methionine α, γ-lyase and 1 μM to 200 μM for homocysteine α, γ-lyase, both surpassing the total physiological total plasma homocysteine concentrations. 2.5 μg /200 μL of enzyme was used for all tests in this example. FIG. 4 illustrates test results along with the relative statistic analyses.

The results shown in FIG. 4 display very good linearity for both enzymes with correlation coefficients of 0.9976 for methionine α, γ-lyase and 0.9980 for homocysteine α, γ-lyase. These results indicate that both enzymes can be used in the disclosed method for the detection of homocysteine. The enzymes have high sensitivities (methionine α, γ-lyase is 1055 pA/μM and homocysteine α, γ-lyase is 95.5 pA/μM) and low detection limits (S>3σ, 37.9 nM for M-lyase and 418.8 nM for H-lyase.) The H-lyase detection limit improved to 314 nM using the same instrumental setup but with different instrumental settings. These detection limit results are better than conventional homocysteine test kit detection limits of about 1 μM.

Methionine α, γ-lyase has an 11 fold higher sensitivity and lower detection limit for homocysteine determination than that of homocysteine α, γ-lyase. Thus, methionine α, γ-lyase is likely advantageous for use in the presently disclosed method. Methionine α, γ-lyase is also a better candidate for fabricating an enzyme immobilized homocysteine biosensor because of its efficiency (by enzyme weight), sensitivity and detection limit results.

### EXAMPLE 5

### Chemical Interference

Tests were conducted to assess the hydrogen sulfide sensor's response to some common agents without using enzymes. Table 3 listed the results of interference tests against ammonia (NH₃), hydrogen peroxide (H₂O₂) and potassium nitrite (KNO₂). It is clear that these compounds will not introduce any interference to the disclosed homocysteine determination method.

TABLE 3
Table 3. Interference based on 10 μM homocysteine
against NH₃, H₂O₂ and KNO₂.

| | NH₃ | H₂O₂ | KNO₂ |
|---|---|---|---|
| concentration (μM) | 60 | 8 | 80 |
| interference, % | 0 | 0 | 0 |

Tests were conducted to assess the homocysteine determination method's response to dopamine, ascorbic acid, dithiothreitol (DTT) and glutathione (GSH). These tests were carried out using the disclosed method, amounts of enzyme and tris buffer solutions and predetermined pHs, i.e., pH 6.5 for methionine α, γ-lyase and pH 7.0 for homocysteine α, γ-lyase. As shown in table 4, dopamine and ascorbic acid provided no interference in testing using either enzyme. The high concentration of DTT caused a substantially high interference in the test method using homocysteine α, γ-lyase, but a negligible interference when using methionine α, γ-lyase. The interference from GSH is small for both enzymes.

TABLE 4
Table 4. The results of interference tests based on 10 μM homocysteine
against dopamine, ascorbic acid, dithiothreitol (DTT) and glutathione
(GSH) for methionine α,γ-lyase (M-lyase) at pH 6.5 and
homocysteine α,γ-lyase (H-lyase) at pH 7.0.

| | | Ascorbic | | |
|---|---|---|---|---|
| | Dopamine* | Acid* | DTT | GSH* |
| concentration (μM) | 20 | 1000 | 300 | 100 |
| M-lyase interference, % | 0 | 0 | 1.15 | 0.27 |
| H-lyase interference, % | 0 | 0 | 75.5 | 0.94 |

*Tests were under the same conditions used for testing homocysteine, i.e. with tris buffer at pH 6.5 and methionine α,γ-lyase.

Cysteine and methionine are the major two amino acids causing significant interference. The reaction between either enzyme and homocysteine proceeds at a different rate than the reaction between the enzyme and cysteine or methionine. Thus, timing of when the electrochemical sensor measurement is taken can be used to minimize interference of the measurement method by cysteine or methionine. It may also possible to test homocysteine and interfering moieties separately, followed by combining the data together to establish concentrations of homocysteine and interfering moieties or to examine the mixed solutions (in order to let homocysteine to compete with the interferers) followed by comparing the results with the pure homocysteine datum.

Additionally, experiments were conducted using sodium phosphate saline (SPS) buffer solution (pH 7.8) as an extra comparison. The concentrations for all three species, cysteine, methionine and homocysteine, were kept or scaled at 10 μM. The results are summarized in table 5. As shown in Table 5, methionine α, γ-lyase at pH 6.5 exhibits smaller interferences than homocysteine α, γ-lyase at pH 7.0 and 7.8 for both cysteine and methionine. Results using the SPS buffer solution also showed more interference than results using the Tris buffer solution.

TABLE 5
Table 5. Summary of the interference tests on equal molar amount of
cysteine (Cys) and methionine (Met) to homocysteine for methionine
α,γ-lyase (M-lyase) at tris buffer pH 6.5, and homocysteine
α,γ-lyase (H-lyase) at tris buffer pH 7.0 and sodium phosphate
saline (SPS) buffer pH 7.8.

| | enzyme | | |
|---|---|---|---|
| | M-lyase | H-lyase | H-lyase |
| buffer | Tris, pH 6.5 | Tris, pH 7.0 | SPS, pH 7.8 |
| cysteine interference % | 3.5 | 5.2 | 11.0 |
| methionine interference % | 2.4 | 3.4 | 8.0 |

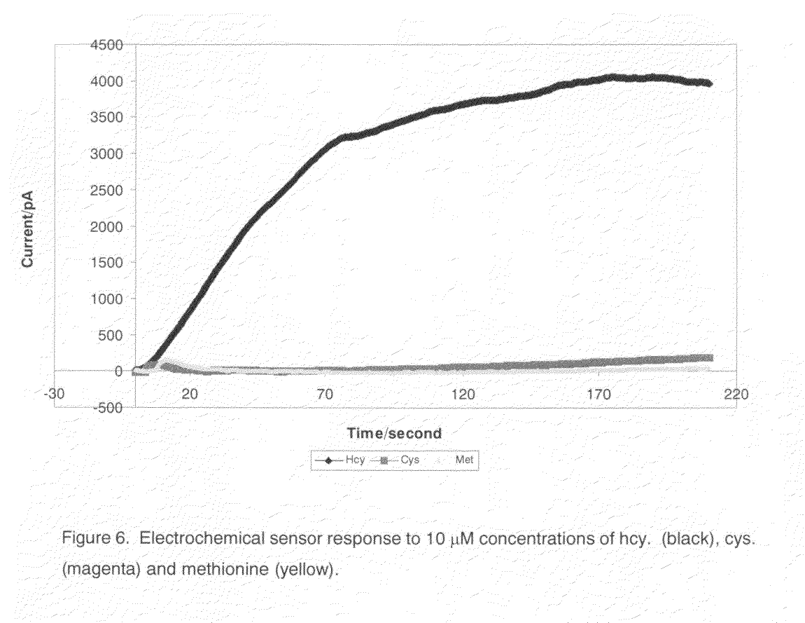

FIG. 6 displays amperometric current profiles of 10 μM homocysteine (black), cysteine (magenta) and methionine (yellow) at tris buffer pH 6.5. The homocysteine current peaked at 175 seconds. At this time the interferences, i.e., the current contributions from cysteine and methionine at 175 seconds, were relatively small at 3.71% and 0.15% respectively. This is because the enzyme activities for cysteine and methionine are both much slower than homocysteine and their peaks come out sluggishly at a much later time. This selectivity feature of the enzymatic reactivity allows this method to distinguish homocysteine from cysteine and methionine by taking the sensor measurement at an early reaction time when the majority of current is contributed from the homocysteine enzymatic reaction, and consequently, the interferences from cysteine and methionine are greatly reduced. The electrochemical sensor method also provides better control over monitoring the timing of the reaction process than conventional homocysteine detection methods. It is noticed that there are small discrepancies on the peak response times from various tests. The inventors speculate that such discrepancies might come from the use of different sensors in these experiments and slight changes of environmental factors, such as ambient temperature, injection position relative to sensor tip, injection speed, manually induced agitation, etc.

### EXAMPLE 6

### Interference of Cysteine and Methionine at 10 Times Higher Concentration

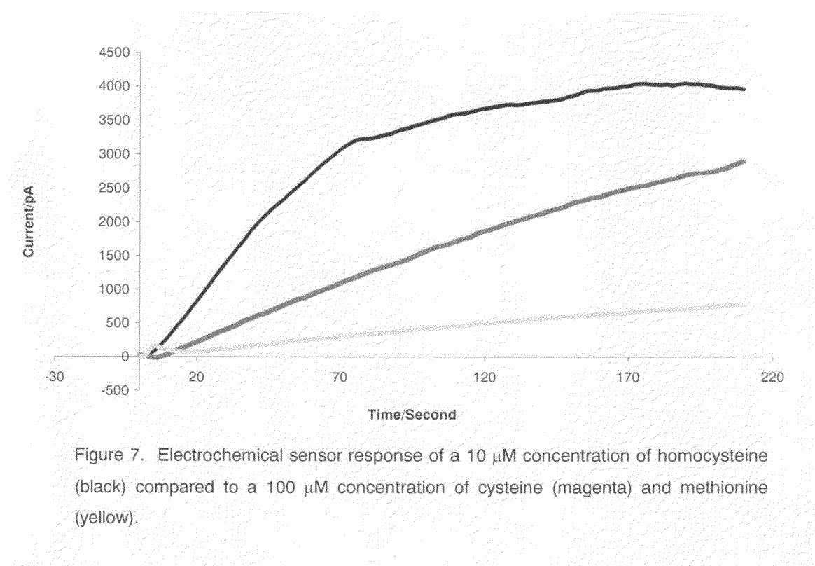

These tests measure homocysteine concentration in samples having an interference level close to the physiological level of cysteine and methionine in human blood plasma (cysteine level around 250 to 274 μM for middle range, and methionine level from 30 up to about 100 μM). Tests using 100 μM of cysteine and 100 μM methionine were performed and the results are illustrated in FIG. 7. The data is listed in Table 6.

TABLE 6

| | Homocysteine | Cysteine | Methionine |
|---|---|---|---|
| time sec. | Peak % | Interference Peak % | Interference Peak % |
| 175 | 100 | 62.2 | 16.0 |
| 78 | 80.0 | 37.5 | 9.2 |
| 42 | 50.0 | 30.3 | 6.8 |
| 30 | 35.0 | 27.8 | 5.9 |

The enzymatic activity of methionine α, γ-lyase for homocysteine is higher (faster) than for cysteine and methionine. This provides a way to reduce this interference from cysteine and methionine during homocysteine measurement by selecting a time for homocysteine measurement before the homocysteine reaction peaks and the interfering compounds are significant. The present method is superior to conventional homocysteine detection methods, which not only present problems with timing the reaction but also suffer from cysteine interference.

The interference from cysteine can be reduced. The interference test work was done using the pH value providing the highest methionine α, γ-lyase enzymatic activity toward homocysteine responses, i.e., pH 6.5. This may not be the best pH condition for minimizing interferences. From the reaction rate point of view, the enzymatic reaction for homocysteine was actually maximized at pH 7.5 and that might be a better pH environment even though the actual response (to homocysteine) would be reduced slightly.

There may be other possible avenues to reduce or remove the interference problem. It may be possible to minimize test interference in other ways. It may be possible to adjust the pH environment of the test sample to maintain adequate homocysteine sensitivity while lowering interference by cysteine and/or methionine. Homocysteine should have different binding properties than cysteine toward organic compounds. The addition of certain aldehydes into the test sample may cause cysteine to form a stable adduct without affecting homocysteine. Such addition could be an excellent in a way for in situ removal of the interference from cysteine. Pretreatment of the test sample with cysteine dioxygenase may lessen cysteine's interference.

### EXAMPLE 7

### Influence of Enzyme Concentration

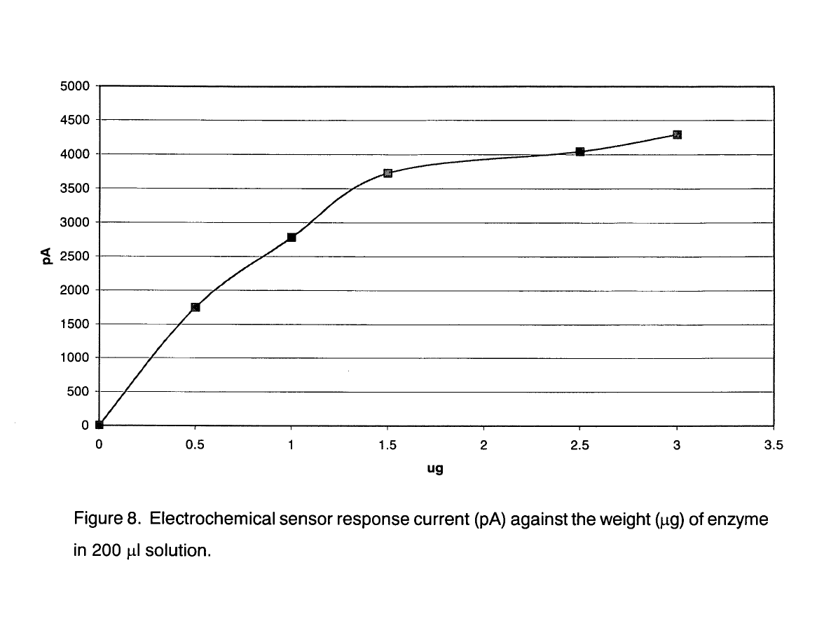

The responses against different concentrations of methionine α, γ-lyase were tested (from 0.5 μg/200 μl to 3.0 μg/200 μl). The results are depicted in FIG. 8. It seems that this enzymatic reaction starts to become saturated from 1.5 μg/200 μl.

Total homocysteine concentration comprises of the sum of the concentrations of free, reduced and free but intra-molecularly bonded homocysteine species. Ideally it would be desirable to measure each of the species separately, however there is presently no simple technique available to measure such low homocysteine concentrations. Consequently, conventional measurement methods for total homocysteine use a strong reducing agent, such as DTT, that is mixed with the sample and followed by an incubation process to convert all species of homocysteine into the free reduced form.

Incubations of two types of bound homocysteine, L-homocysteine thiolactone (cyclically bonded intramolecular form) and L-homocysteine (disulphide bonded dimer), were carried out using either 3 times amount of ascorbic acid or 3 times amount of DTT at either room or 40° C. The incubation times were 60 minutes at room temperature and 15 minutes at 40° C. The results (not shown) demonstrate some difficulties in completely reducing both bound forms in all the experiments, while the denaturation of the homocysteine was observed at both temperatures. The reducing step is not only more cumbersome but also introduces uncertainties, such as denaturation, incomplete reduction, etc., to the accurate determination of homocysteine. In addition, DTT could also introduce interference especially when using homocysteine α, γ-lyase as described in the previous section. Therefore, it would be advantageous to avoid the reduction/incubation step in any homocysteine measurement process. However, conventional homocysteine test methods lack the high sensitivity and low detection limit needed to eliminate this step.

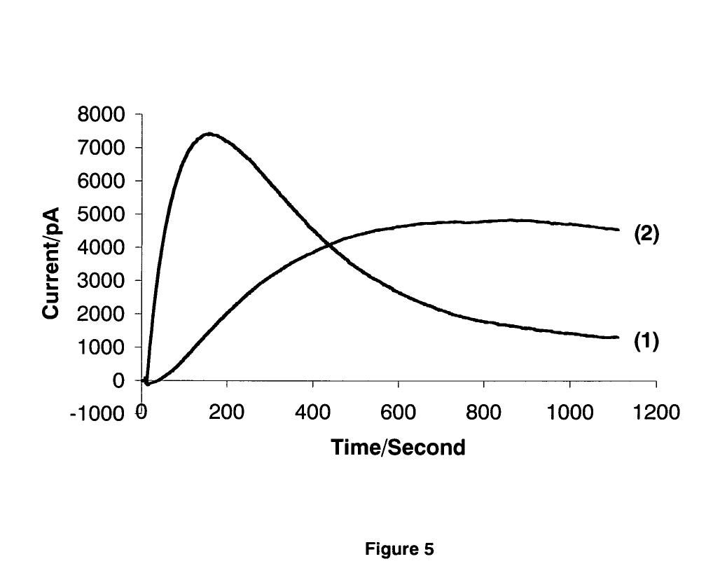

The disclosed electrochemical sensor method using methionine α, γ-lyase has an extremely low detection limit of 37.9 nM. This is more than adequate to detect the 100 plus nM range of physiologically free plasma homocysteine concentration. Additionally, methionine α, γ-lyase expresses strong reactivity and demonstrates the ability to break the homocysteine dimer without the assistance of any reducing agent. This ability could enhance the detection ability further. FIG. 5 illustrates the current generated from the enzymatic reaction of the same concentrations of homocysteine and a 50% homocysteine/50% homocysteine dimer. The enzymatic reaction of homocysteine appeared slow. This might be because methionine α, γ-lyase needs extra time to break down the dimer first before it can react with the free homocysteine. The disclosed electrochemical sensor method for determination of homocysteine is the first method that allows omission of the presently required reduction/incubation steps. Further, the use of methionine α, γ-lyase decreases test time and also reduces the experimental errors associated with increased experimental time such as change of temperature and systemic drifting of instrumentation.

The method of detecting homocysteine in an aqueous sample using the ISO-H2S-2 hydrogen sulfide sensor conjunction with enzyme treatment is accurate, fast and highly sensitive. The detection limit of this method is much lower than conventional methods. The low detection limit may allow detection of different forms of homocysteine in an aqueous sample such as blood. The linearity is high at R²=0.9987 for a wider range of homocysteine levels than are present in human plasma. The disclosed method utilizes real-time dynamic data acquisition and solves the timing problems resident in conventional measurement methods.

While preferred embodiments have been set forth for purposes of illustration, the foregoing description should not be deemed a limitation of the disclosure herein. Accordingly, various modifications, adaptations and alternatives may occur to one skilled in the art without departing from the spirit and scope of the present disclosure.

What is claimed:

1. A method of detecting an amino acid in an aqueous sample, comprising:
providing an aqueous sample comprising a member selected from an amino acid having a sulfur atom, a homocysteine derivative having a sulfur atom or a combination thereof;
combining the test sample with an enzyme to form a mixture comprising hydrogen sulfide or ammonia;
providing an electrochemical sensor; and
detecting the presence of at least one of hydrogen sulfide or ammonia in the mixture using the electrochemical sensor.

2. The method of claim 1 wherein the mixture comprises H₂S and the step of detecting comprises quantitatively measuring the amount of H₂S in the mixture.

3. The method of claim 1 wherein the mixture comprises H₂S and the step of detecting comprises quantitatively measuring the amount of H₂S in the mixture to provide a signal proportional to an amount of the amino acid present in the sample.

4. The method of claim 1 wherein the mixture comprises H₂S and the electrochemical sensor comprises a H₂S permeable membrane, a working electrode and a reference electrode.

5. The method of claim 1 wherein the amino acid S atom is part of a thiol group.

6. The method of claim 1 wherein the amino acid is homocysteine.

7. The method of claim 1 wherein the homocysteine derivative comprises an oxidized homocysteine derivative.

8. The method of claim 1 wherein the enzyme is methionine α, γ-lyase.

9. The method of claim 1 wherein the mixture comprises H₂S and the electrochemical sensor is an H₂S sensor.

10. The method of claim 1 wherein the mixture comprises ammonia and the electrochemical sensor is an ammonia sensor.

11. The method of claim 1 including combining a disulfide bond reducing agent with the test sample prior to combining the test sample with an enzyme.

12. The method of claim 1 including combining a disulfide bond reducing agent and an enzyme with the test sample substantially concurrently.

13. The method of claim 11 wherein the disulfide bond reducing agent is tris-(2-carboxyethyl)phosphine.

14. The method of claim 12 wherein the disulfide bond reducing agent is tris-(2-carboxyethyl)phosphine.
